(19) United States
(12) Patent Application Publication
(10) Pub. No.: US 2007/0142545 A1
(43) Pub. Date: Jun. 21, 2007

(54) Multicomponent systems; method for producing the same and use thereof

(75) Inventors: Bernhard Lettmann, Drensteinfurt (DE); Egbert Nienhaus, Ascheberg (DE)

Correspondence Address: BASF CORPORATION;Patent Department, 1609 BIDDLE AVENUE, MAIN BUILDING, WYANDOTTE, MI, 48192, US

(73) Assignee: BASF COATINGS AKTIENGESELLSCHAFT, Münster (DE)

(21) Appl. No.: 10/598,195

(22) PCT Filed: Jan. 26, 2005
(86) PCT No.: PCT/EP05/50385

§ 371 Date: Aug. 21, 2006

(30) Foreign Application Priority Data
Feb. 26, 2004 (DE) 102004009282.6

(51) Int. Cl. C08G 18/08

(52) U.S. Cl. 524/589

(57) ABSTRACT

Disclosed herein are multicomponent systems, processes for preparing them, and their use for preparing water-in-oil dispersions curable thermally or both thermally and with actinic radiation, and also their use as coating materials, adhesives, and sealants for producing coatings, adhesive layers, and seals. In one embodiment, a multicomponent system compries: (I) at least one water-in-oil dispersion comprising water and at least one water-soluble and/or water-dispersible, oligomeric and/or polymeric binder (A) having at least two isocyanate-reactive functional groups in solution and/or dispersion in at least one organic solvent; (II) at least one water-free liquid component comprising at least one polyisocyanate (B); and (III) water or at least one aqueous component comprising at least one binder (A) in dispersion and/or solution in water.

The present invention relates to new multicomponent systems. The present invention also relates to a new process for preparing multicomponent systems. The present invention further relates to the use of the new multicomponent systems and of the multicomponent systems prepared by the new process for preparing oil-in-water dispersions curable thermally or both thermally and with actinic radiation. The present invention relates not least to the use of the oil-in-water dispersions curable thermally and with actinic radiation as coating materials, adhesives, and sealants for producing coatings, adhesive layers, and seals.

Aqueous multicomponent systems for preparing oil-in-water dispersions curable thermally or both thermally and with actinic radiation and comprising or consisting of at least the following components:
(I′) at least one water-free liquid component which comprises at least one water-soluble and/or water-dispersible, oligomeric and/or polymeric binder (A) having at least two isocyanate-reactive functional groups in solution and/or dispersion in at least one organic solvent;
(II) at least one water-free liquid component comprising or consisting of at least one polyisocyanate (B); and
(III) water or at least one aqueous component which comprises at least one binder (A) in dispersion and/or solution in water;
   are known from American patent U.S. Pat. No. 5,466,754 A1, international patent application WO 97/14731 A1, German patent applications DE 44 21 823 A1, DE 198 55 125 A1, DE 198 55 167 A1, DE 199 14 899 A1 or DE 199 04 317 A1 or European patent EP 1 056 786 B1.

It is known that for preparing the corresponding oil-in-water dispersions curable thermally or both thermally and with actinic radiation at least one component (I′), at least one component (II) and at least one component (III) are mixed with one another. Normally in this case first the water-free liquid components (I′) and (II) are mixed with one another and then the resultant mixture (I′/II) is combined with the aqueous component (III). The resultant curable oil-in-water dispersions are used in particular as coating materials, adhesives, and sealants for producing coatings, adhesive layers, and seals.

Known in addition from the comparative experiments of international patent application WO 97/14731 A1 is a process in which first of all component (III) comprising at least one binder (A) is mixed with the water-free component (I′) so as to give an aqueous-organic component (I′/III) which owing to its high water content, however, is not a water-in-oil dispersion. The aqueous-organic component (I′/III) is subsequently mixed with component (II). The aqueous-organic component (I′/III) and component (II) therefore form a two-component system. The resultant aqueous, thermally curable mixtures, however, provide clearcoats which exhibit instances of clouding, gray haze, and poor leveling (cf. WO 97/14731 A1, page 58, Table 1).

It is known, moreover, from the comparative experiments “Comparative Examples 1 and 2”, column 11 line 62 to column 13 line 21, of U.S. Pat. No. 5,466,754 A1 (with direct reference to American patent U.S. Pat. No. 5,075,370 A1) a three-component system comprising an aqueous dispersion or solution of the binder (A) as component (I″)—i.e. an oil-in-water dispersion—and also components (II) and (III). This three-component system, however, provides aqueous, thermally curable mixtures which are inhomogeneous and cloudy and which after stirring suffer phase separation or which are unstable and form precipitates after only 1 to 2 hours.

Known from international patent application WO 98/38230 A1 is a three-component system comprising an aqueous-organic component (I″) having a water content of 40% by weight and also components (II) and (III). In view of its high water content the aqueous-organic component (I″) is not a water-in-oil dispersion (I). To prepare thermally curable oil-in-water dispersions, component (I″) is mixed with component (II), so that only at this stage of the process does a water-in-oil dispersion result. The water-in-oil dispersion is diluted further with water, to give an oil-in-water dispersion. According to the international patent application this dispersion is stable and has a comparatively long processing time and a comparatively low VOC (volatile organic compound) content. It is said to provide coatings, especially clearcoats, which are of high clarity and high gloss and contain few if any microbubbles.

Where the known, aqueous, thermally curable mixtures are prepared from the known multicomponent systems it is necessary when mixing components (I′) to (III) and when homogenizing the resultant mixtures to employ comparatively high shearing forces, so that the processes can be carried out only by means of mixing equipment such as stirrers or dissolvers. For refinishing, especially automotive refinishing, however, it is also necessary that comparatively small amounts of oil-in-water dispersions curable thermally or both thermally and with actinic radiation can be prepared by hand from multicomponent systems. With the known multicomponent systems, however, this is not possible, or not to the degree necessary.

It is an object of the present invention to provide new multicomponent systems which no longer have the disadvantages of the prior art but which instead are easy to prepare and which allow oil-in-water dispersions curable thermally or both thermally and with actinic radiation to be prepared from two or more components by means of manual mixing, without problems and with very good reproducibility.

The resultant oil-in-water dispersions curable thermally or both thermally and with actinic radiation ought to be stable, ought to have a practical processing time or pot life of several hours, and ought to be outstandingly suitable for use in particular as coating materials, especially clearcoat materials, adhesives, and sealants.

The coating materials, especially the clearcoat materials, ought to provide coatings, especially clearcoats, of high gloss, high clarity, high transparency, and very good leveling with complete or substantial freedom from surface defects.

The adhesives ought to provide adhesive layers which join substrates to one another permanently even under climatic conditions which are difficult and/or fluctuate rapidly between extremes.

The sealants ought to provide seals which even under conditions which are difficult and/or fluctuate rapidly between extremes, and at relatively high pressures, are capable of permanently sealing even with respect to aggressive chemicals.

The invention accordingly provides the new multicomponent systems which consists of or comprise at least the following components:
(I) at least one water-in-oil dispersion comprising water and at least one water-soluble and/or water-dispersible, oligomeric and/or polymeric binder (A) having at least two isocyanate-reactive functional groups in solution and/or dispersion in at least one organic solvent;
(II) at least one water-free liquid component which consists of or comprises at least one polyisocyanate (B); and
(III) water or at least one aqueous component which comprises at least one binder (A) in dispersion and/or solution in water.

The new multicomponent systems are referred to below as “multicomponent systems of the invention”.

The invention further provides a new process for preparing the multicomponent systems of the invention from multicomponent systems which comprise at least
(I′) at least one water-free liquid component which comprises at least one water-soluble and/or water-dispersible, oligomeric and/or polymeric binder (A) having at least two isocyanate-reactive functional groups in solution and/or dispersion in at least one organic solvent;
(II) at least one water-free liquid component which consists of or comprises at least one polyisocyanate (B); and
(III) water or at least one aqueous component which comprises at least one binder (A) in dispersion and/or solution in water;
   which involves mixing a portion of at least one component (III) with at least one component (I′) to give at least one water-in-oil dispersion (I), and which is referred to below as “process 1 of the invention”.

The invention additionally provides the new process for preparing oil-in-water dispersions curable thermally or both thermally and with actinic radiation, which comprises using a multicomponent system which consists of or comprises at least the following components:
(I′) at least one water-free liquid component which comprises at least one water-soluble and/or water-dispersible, oligomeric and/or polymeric binder (A) having at least two isocyanate-reactive functional groups in solution and/or dispersion in at least one organic solvent;
(II) at least one water-free liquid component which consists of or comprises at least one polyisocyanate (B); and
(III) water or at least one aqueous component which comprises at least one binder (A) in dispersion and/or solution in water;
   where at least one component (I′), at least one component (II), and at least one component (III) are mixed with one another and where
(1) a portion of at least one component (III) is mixed with at least one component (I′) to give at least one water-in-oil dispersion (I),
(2) the water-in-oil dispersion(s) (I) is or are mixed with at least one component (II), and
(3) the resultant mixture(s) (I/II) is or are mixed with water or at least one component (III) to give at least one oil-in-water dispersion.

The new process for preparing oil-in-water dispersions curable thermally or both thermally and with actinic radiation is referred to below as “process 2 of the invention”.

The invention additionally provides for the new use of the multicomponent systems of the invention and of the multicomponent systems of the invention prepared by means of process 1 of the invention, and also of process 2 of the invention, for preparing oil-in-water dispersions curable thermally or both thermally and with actinic radiation.

The invention provides, furthermore, for the new use
of the oil-in-water dispersions curable thermally or both thermally and with actinic radiation prepared from the multicomponent systems of the invention,
of the oil-in-water dispersions curable thermally or both thermally and with actinic radiation obtained from the multicomponent systems of the invention prepared by means of process 1 of the invention, and
of the oil-in-water dispersions curable thermally or both thermally and with actinic radiation prepared by means of process 2 of the invention
   as coating materials, adhesives, and sealants for producing coatings, adhesive layers, and seals.

In the light of the prior art it was surprising and unforeseeable for the skilled worker that the object on which the present invention was based could be achieved by means of the multicomponent systems of the invention, of process 1 of the invention, and of process 2 of the invention.

In particular it was surprising that the multicomponent systems of the invention no longer had the disadvantages of the prior art but instead could be prepared simply and with outstanding reproducibility by means of process 1 of the invention.

Furthermore, the multicomponent systems of the invention and the multicomponent systems prepared by means of process 1 of the invention allowed oil-in-water dispersions curable thermally or both thermally and with actinic radiation to be prepared with outstanding reproducibility and without problems, by mixing by hand, from components (I) to (III).

Not least, process 2 of the invention allowed oil-in-water dispersions curable thermally or both thermally and with actinic radiation to be prepared with outstanding reproducibility and without problems, by mixing by hand, from components (I′) to (III).

The resultant oil-in-water dispersions curable thermally or both thermally and with actinic radiation were stable, had a practical processing time or pot life of several hours, and could be used to outstanding effect in particular as coating materials, especially clearcoat materials, adhesives, and sealants.

The coating materials, especially the clearcoat materials, gave coatings, especially clearcoats, of high gloss, high clarity, high transparency, and very good leveling with complete or substantial absence of surface defects.

The adhesives gave adhesive layers which joined the substrates to one another permanently even under climatic conditions which were difficult and/or which fluctuated rapidly between extremes.

The sealants gave seals which were capable of sealing permanently even with respect to aggressive chemicals and even under conditions which were difficult and/or fluctuated rapidly between extremes and under relatively high pressures.

The multicomponent systems of the invention comprise at least components (I) to (III).

They may additionally comprise at least one further component, such as, for example, the finely divided solid component (IV), which is described in detail in German patent application DE 199 04 317 A1, page 3 line 6 to page 8 line 10, and which consists of or comprises at least one, especially one, optionally water-soluble or water-dispersible, oligomeric and/or polymeric binder (A).

The components (I) to (III) and also the further components where present can also be provided in the form of a mixer system or modular system (cf., for example, German patent application DE 199 04 330 A1) comprising, for example, two or more different pigmented components (I) as base colors, so that from a comparatively small number of base colors it is possible, by means of paint mixing formulae, to provide coating materials which give coatings having a very wide variety of shades and optical effects.

The multicomponent systems of the invention comprise at least one, especially one, water-in-oil dispersion (I) as component(s) (I) comprising water as disperse phase and an organic phase as continuous phase. If desired it is also possible for finely divided solid particles such as pigments, for example, to be present as a further disperse phase.

The water content of the water-in-oil dispersions (I) may vary widely; what is important is that it is below the water content from which phase inversion occurs. The position of the point from which phase inversion occurs is influenced by factors including the constituents present in the water-in-oil dispersions (I), particularly the binders (A) and their degree of neutralization. In general there is no phase inversion if the water content, particularly with a degree of neutralization of the binders (A) described below of >50%, is <40%, preferably <30%, and in particular <20% by weight.

The water content is preferably at least 5%, more preferably at least 10%, and in particular at least 15% by weight.

The water-in-oil dispersions (I) further comprise at least one water-soluble and/or water-dispersible, oligomeric and/or polymeric binder (A) having at least two, preferably at least three, and in particular at least four isocyanate-reactive functional groups in solution and/or dispersion in at least one organic solvent.

Examples of suitable binders (A) for use in the water-in-oil dispersions and/or in components (I) are known from German patent applications
DE 44 21 823 A1, page 4 line 4 to page 11 line 17;
DE 198 55 125 A1, page 3 line 14 to page 4 line 1 and page 4 line 2 to page 11 line 39;
DE 198 55 167 A1, page 3 para [0032] to page 12 para [0121];
DE 199 04 317 A1, page 3 line 6 to page 12 line 19; or
DE 199 14 899 A1, page 3 line 15 to page 8 line 32 and page 8 line 32 to page 17 line 6;

International Patent Applications
WO 97/14731 A1, page 10 line 30 to page 36 line 5; or
WO 98/38230 A1, page 10 line 15 to page 13 line 20; or

American Patent
U.S. Pat. No. 5,466,745 A1, column 5 line 43 to column 7 line 6.

The water-in-oil dispersions (I) preferably contain the binders (A) in the amounts as described in German patent applications
DE 44 21 823 A1, page 11 lines 9 to 17;
DE 198 55 125 A1, page 12 lines 23 to 36;
DE 198 55 167 A1, page 12 para [0121];
DE 199 04 317 A1, page 12 lines 12 to 19; or
DE 199 14 899 A1, page 16 line 66 to page 17 line 6.

Suitable organic solvents are all those which under the conditions of the preparation, storage, and further processing of the water-in-oil dispersions (I) do not react with the binders (A) or with water. In respect of the polyisocyanates of component (II), described below, the organic solvents may be inert or reactive. They may also be reactive in the sense of participating in the curing with actinic radiation. If they are reactive they are then referred to as reactive diluents. Examples of suitable organic solvents are known from German patent applications DE 199 14 899 A1, page 17 lines 23 to 33, in conjunction with page 11 line 47 to page 12 line 8, or DE 101 29 970 A1, page 11 para [0102] with reference to German patent application DE 198 18 735 A1, column 7 lines 1 to 25. The organic solvents are preferably water-dilutable.

The water-in-oil dispersions or components (I) may otherwise comprise, in effective amounts, conventional additives, such as neutralizing agents; physically curable binders other than the above-described binders (A); pigments; molecularly dispersely soluble dyes; light stabilizers, such as UV absorbers and reversible free-radical scavengers (HALS); antioxidants; wetting agents; emulsifiers; slip additives; polymerization inhibitors; thermal crosslinking catalysts; thermolabile free-radical initiators; photoinitiators and photocoinitiators; adhesion promoters; leveling agents; film-forming auxiliaries; rheological assistants or rheology control additives (thickeners and pseudoplastic sag control agents, SCA); flame retardants, corrosion inhibitors; waxes; siccatives; biocides and/or flatting agents. Further examples of suitable additives are described in German patent applications
DE 44 21 823 A1, page 11 lines 18 to 30 and page 11 line 35 to page 12 line 3;
DE 199 14 899 A1, page 17 lines 35 to 43, page 17 line 39 to page 18 line 37, and page 19 lines 10 to 66;
DE 101 29 970 A1, page 11 para [0106] to page 12 para [0121], and page 12 para [0123]; or in
the textbook “Lackadditive” [Additives for coatings] by Johan Bieleman, Wiley-VCH, Weinheim, N.Y., 1998.

The water-free liquid components (II) comprise at lest one, especially one, polyisocyanate (B). The polyisocyanates (B) may also contain reactive functional groups which can be activated with actinic radiation and so are able to participate in the curing with actinic radiation. Such polyisocyanates (B) are referred to below as “dual-cure-polyisocyanates (B)”.

The liquid components (II) are water-free. This means that they contain no water or contain only traces of water which are entrained unintentionally during the preparation and/or handling of components (II).

Examples of suitable polyisocyantes (B) for use in components (II) are known from German patent applications
DE 44 21 823 A1, page 12 lines 4 to 35; or
DE 199 14 899A1, page 18 line 40 to page 19 line 9 and page 19 line 67 to page 20 line 12.

Examples of suitable dual-cure polyisocyanates (B) for use in components (II) are known from German patent application DE 101 29 970 A1, page 2 para [0008] with reference to European patent application EP 0 928 800, and page 6 para [0042] to page 11 para [0099].

Besides the polyisocyanates (B) described above, the components (II) may comprise the above-described organic solvents, preferably the inert, water-dilutable solvents, other crosslinking agents which contain no free isocyanate groups, such as the crosslinking agents described in German patent application DE 199 14 899 A1, page 19 lines 10 to 66, for example, and/or the above-described additives, preferably additives containing no isocyanate-reactive functional groups.

The components (III) comprise water, preferably deionized water. The water may include effective amounts of the above-described additives (cf. German patent application DE 44 21 823 A1, page 12 line 63 to page 13 line 3), especially rheological assistants or rheology control additives.

The components (III) may also be aqueous components (III) which comprise at least one of the above-described binders (A) in solution and/or dispersion in water. These aqueous components (III) preferably comprise at least one of the above-described additives (cf. also international patent application WO 97/14731 A1, page 43 line 18 to page 46 line 30), in particular a Theological assistant or rheology control additive.

The multicomponent systems of the invention are preferably prepared by means of process 1 of the invention.

In that case the starting point according to the invention is formed by multicomponent systems which comprise at least
(I′) at least one, especially one, component which comprises at least one water-soluble and/or water-dispersible, oligomeric and/or polymeric binder (A) having at least two isocyanate-reactive functional groups in solution and/or dispersion in at least one organic solvent and is water-free in the sense referred to above;
(II) at least one, especially one, water-free liquid component which consists of or comprises at least one polyisocyanate (B); and
(III) water or at least one, especially one, aqueous component which comprises at least one binder (A) in dispersion and/or solution in water.

It is preferred to use multicomponent systems known per se, particularly three-component systems or four-component systems, such as are described in detail in, for example, international patent application WO 97/14731 A1, German patent applications DE 44 21 823 A1, DE 198 55 125 A1, DE 198 55 167 A1 or DE 199 04 317 A1 or American patent U.S. Pat. No. 5,466,754 A1.

In accordance with the invention a portion of at least one, especially one, component (III) is mixed with at least one, especially one, component (I′) to give at least one, especially one, water-in-oil dispersion (I) as described above. The amount of component (III) is chosen so that there can be no phase inversion to form an oil-in-water dispersion. This can also be carried out as part of process 2 of the invention.

In terms of method the preparation of components (I) to (III), i.e. of the multicomponent systems of the invention, has no peculiar features but instead takes place by the mixing and homogenizing of the above-described constituents using conventional mixing techniques and equipment such as stirred tanks, stirrer mills, extruders, compounders, Ultra-Turrax, inline dissolvers, static mixers, toothed-wheel dispersers, pressure relief nozzles and/or microfluidizers, in the absence of actinic radiation where appropriate, i.e., where the resultant components (I) to (III) include constituents which can be activated by actinic radiation.

The multicomponent systems of the invention serve for preparation of the curable oil-in-water dispersions.

The curable oil-in-water dispersions have a solids content, i.e., an amount of constituents which constitute the coatings, adhesive layers or seals produced from the mixtures, of preferably from 10 to 90%, more preferably from 20 to 80%, and in particular from 30 to 70% by weight, based in each case on a curable oil-in-water dispersion.

Based on the total amount of the water present in them and of the organic solvents present in them, the curable oil-in-water dispersions contain preferably more than 50%, more preferably at least 55%, and in particular at least 60% by weight of water, so that the solubility properties are determined essentially by the water.

The curable oil-in-water dispersions are curable thermally. This means that they can be cured at room temperature or at higher temperatures. It is possible here to use the customary and known equipment, such as forced air ovens, hot air blowers or radiant heaters, especially NIR or IR radiation or microwave heaters.

The curable oil-in-water dispersions may also be curable both thermally and with actinic radiation, this being referred to by those in the art as dual cure. By actinic radiation is meant electromagnetic radiation, such as near infrared (NIR), visible light, UV radiation, X-rays or gamma radiation, especially UV radiation, and corpuscular radiation, such as electron beams, beta radiation, neutron beams, proton beams or alpha radiation, especially electron beams. For curing it is possible to use the conventional equipment, such as UV lamps or electron beam sources (cf. also German patent application DE 101 29 970 A1, page 13 para [0132]).

The curable oil-in-water dispersions are prepared by mixing at least components (I) to (III) of the multicomponent systems of the invention, preferably as part of process 2 of the invention, which involves
(1) mixing a portion at least of component (III) with at least one component (I′) to give at least one water-in-oil dispersion (I),
(2) mixing the water-in-oil dispersion(s) (I) with at least one component (II), and
(3) mixing the resultant mixture(s) (I/II) with water or with at least one component (III) to give at least one curable oil-in-water dispersion.

The amounts of components (I) and (II) here are preferably chosen so as to give an equivalent ratio of isocyanate groups to isocyanate-reactive groups of from 2:1 to 1:2, more preferably from 1.5:1 to 1:1.5, and in particular from 1.2:1 to 1:1.2.

As part of process 2 of the invention it is preferred for the resultant mixture(s) (I/II) to be processed further rapidly.

For the mixing it is possible to use the mixing equipment described above. It is, however, a particular advantage of the multicomponent systems of the invention, of process 1 of the invention, and of process 2 of the invention that mixing may also take place manually, without adverse effect on the profile of performance properties of the curable water-in-oil dispersions.

All in all, the multicomponent systems of the invention, process 1 of the invention, and process 2 of the invention allow the purposive preparation of small amounts of curable oil-in-water dispersions for solving particular problems: for example, the refinish of minor damage to painted substrates, such as automobile bodies, the adhesive bonding of small substrates or the production of small seals.

The curable oil-in-water dispersions prepared inventively have a pot life or processing life of several hours. This makes job planning considerably easier for users.

As a result the dispersions can be employed very widely. In particular they are suitable as coating materials, adhesives, and sealants for producing coatings, adhesive layers, and seals having outstanding performance properties.

In particular the coating materials are outstandingly suitable for producing single-coat and multicoat clearcoat finishes and also single-coat and multicoat, color and/or effect, electrically conductive, magnetically shielding and/or fluorescent coatings, in particular in accordance with the wet-on-wet method, in which a pigmented basecoat material, in particular an aqueous basecoat material, is applied to the surface of the substrate and the resultant basecoat film is then dried, without being cured, and is overcoated with a clearcoat film. Thereafter the two films are cured together.

The application of the aqueous curable mixtures prepared by means of the process of the invention, in particular the coating materials, adhesives, sealants, has no peculiar features in terms of method but can instead take place by all customary application methods, such as spraying, knifecoating, brushing, flowcoating, dipping, trickling or rolling, for example. It may be advisable to operate in the absence of actinic radiation, in order to prevent premature crosslinking of the aqueous curable mixtures, in particular the coating materials, adhesives, and sealants.

The coating materials, adhesives, and sealants can therefore be used for coating, adhesively bonding, and sealing substrates of any kind, especially bodies of means of transport, including means of transport operated by engine power and/or muscle power, such as automobiles, trucks, buses, bicycles, rail vehicles, watercraft and aircraft, and parts thereof, constructions and parts thereof, doors, windows, furniture, small industrial parts, mechanical, optical, and electronic components, coils, containers, packaging, hollow glassware, and articles of everyday use.

### EXAMPLES

### Preparation Example 1

The Preparation of the Organic Solution of a Water-Soluble or Water-Dispersible Methacrylate Copolymer (A)

A stainless steel reactor equipped with stirrer, reflux condenser and three feed vessels was charged with 402.7 parts by weight of ethyl ethoxypropionate and this initial charge was heated to 130° C. Subsequently at this temperature a monomer mixture of 50 parts by weight of styrene, 20.5 parts by weight of methyl methacrylate, 26.6 parts by weight of lauryl methacrylate, 56.9 parts by weight of hydroxyethyl acrylate, 41.4 parts by weight of tert-butyl acrylate and 46.1 parts by weight of butyl methacrylate was metered into the initial charge at a uniform rate over the course of 2.5 hours, with stirring, from the first feed vessel. At the same time, from the second feed vessel, an initiator solution of 34.6 parts by weight of ethyl ethoxypropionate and 21.2 parts by weight of tert-butyl peroxyethylhexanoate was metered in at a uniform rate over the course of 2.5 hours. The resultant reaction mixture was stirred at 130° C. for an hour.

Subsequently, from the third feed vessel, at this temperature, a monomer mixture of 30 parts by weight of styrene, 12.3 parts by weight of methyl methacrylate, 16 parts by weight of lauryl methacrylate, 72.3 parts by weight of hydroxyethyl acrylate, 27.6 parts by weight of butyl methacrylate, 24.9 parts by weight of tert-butyl acrylate and 18.3 parts by weight of acrylic acid was metered into the inital charge at a uniform rate over the course of 1.5 hours, with stirring. Beginning simultaneously, from the second feed vessel, an initiator solution of 25.7 parts by weight of ethyl ethoxypropionate and 15.7 parts by weight of tert-butyl peroxyethylhexanoate was metered in at a uniform rate over the course of 2 hours.

The resultant reaction mixture was stirred at 130° C. for 2 hours. Subsequently at 100° C. the ethyl ethoxypropionate was distilled off under vacuum until a solids content of 80% by weight was reached. Following the addition of 40.2 parts by weight of butyl glycol at 60° C. a solids content of 75% by weight was set using ethyl ethoxypropionate. The methacrylate copolymer (A) had an acid number of 30 mg KOH/g resin solids and a viscosity of 3.5 dPas (at 55 percent in ethyl ethoxypropionate at 23° C.).

The methacrylate copolymer (A) was used to prepare component (I).

### Preparation Example 2

The preparation of the Aqueous Dispersion of a Water-Soluble or Water-Dispersible Polyurethane (A)

A stainless steel reactor suitable for polycondensation reactions was charged with 297.2 parts by weight of neopentyl glycol hydroxypivalate, 32.8 parts by weight of phthalic anhydride, 5.7 parts by weight of 2-butyl-2-ethylpropane-1,3-diol, 133.5 parts by weight of neopentyl glycol and 346.4 parts by weight of isophthalic acid and also 11.2 parts by weight of azeotrope former. The reaction mixture was subsequently heated with stirring, during which the water of condensation was removed continuously, until an acid number of 3.5 mg KOH/g was reached. The resultant polyester was cooled to 60° C. and adjusted with methyl ethyl ketone to a solids content of 80% by weight. The viscosity of the polyester was 3.5 dPas (at 60 percent in ethyl ethoxypropionate at 23° C.).

A stainless steel reactor suitable for polyurethane synthesis was charged with 264.7 parts by weight of the polyester, 2.3 parts by weight of 2-butyl-2-ethylpropane-1,3-diol, 24.4 parts by weight of dimethylolpropionic acid and 112.4 parts by weight of m-tetramethylxylylidene diisocyanate (TMXDI) and this initial charge was reacted at 82° C. until the isocyanate content was constant. Subsequently 36.2 parts by weight of trimethylolpropane were added, after which the reaction mixture was heated further until the end of the reaction. Following the addition of 44.5 parts by weight of methyl ethyl ketone the reaction mixture was neutralized with 13 parts by weight of dimethylethanolamine and dispersed in 480 parts by weight of deionized water, which was at a temperature of 60° C. Subsequently the methyl ethyl ketone was distilled off under vacuum. The polyurethane dispersion (A) was adjusted with deionized water to a solids content of 40% by weight. It had an acid number of 30 mg KOH/g resin solids and a pH of 7.2.

The aqueous dispersion of the polyurethane (A) was used for preparing component (III).

### Preparation Example 3

The Preparation of a Dispersion of a Water-Soluble or Water-Dispersible Methacrylate Copolymer (A)

A stainless steel reactor equipped with stirrer, reflux condenser and three feed vessels was charged with 94 parts by weight of methyl isobutyl ketone and this initial charge was heated to 110° C. Subsequently, at this temperature, a monomer mixture of 32.9 parts by weight of styrene, 38.3 parts by weight of methyl methacrylate, 22 parts by weight of lauryl methacrylate, 49.5 parts by weight of hydroxyethyl methacrylate and 43.9 parts by weight of butyl methacrylate was metered into the initial charge at a uniform rate over the course of three hours from the first feed vessel. Beginning at the same time, from the second feed vessel, an initiator solution of 25.8 parts by weight of methyl isobutyl ketone and 11.3 parts by weight of tert-butyl peroxyethylhexanoate was metered in at a uniform rate over the course of three hours. The resultant reaction mixture was stirred at 110° C. for an hour.

Subsequently, at this temperature, a monomer mixture of 14.1 parts by weight of styrene, 16.4 parts by weight of methyl methacrylate, 9.4 parts by weight of lauryl methacrylate, 52.4 parts by weight of hydroxyethyl methacrylate, 18.8 parts by weight of butyl methacrylate and 15.9 parts by weight of acrylic acid was metered into the initial charge from the third feed vessel over the course of 1.5 hours. Beginning at the same time, from the second feed vessel, an initiator solution of 16.6 parts by weight of methyl isobutyl ketone and 7.5 parts by weight of tert-butyl peroxyethylhexanoate was metered in at a uniform rate over two hours. The resultant reaction mixture was held at 110° C. for two hours and then admixed with 17.5 parts by weight of dimethylethanolamine.

Subsequently the reaction mixture was dispersed at 80° C. in 149.5 parts by weight of deionized water. The resultant dispersion was held at 80° C. for an hour. 330 parts by weight of deionized water were added and the methyl isobutyl ketone was distilled off under vacuum.

The resultant dispersion of methacrylate copolymer (A) was adjusted with deionized water to a solids content of 40% by weight. It had a pH of 7.5 and an acid number of 40 mg KOH/g resin solids.

The dispersion of the methacrylate copolymer (A) was used for preparing component (III).

### Preparation Example 4

The Preparation of a Low Molecular Mass Hydrophobic Polyester

A stainless steel reactor was charged with 308 parts by weight of hexahydrophthalic anhydride and 134 parts by weight of trimethylolpropane and this initial charge was heated to 150° C. Subsequently 457 parts by weight of Cardura® E 10 (Versatic acid® glycidyl ester) were metered into the initial charge at a uniform rate over the course of an hour. The reaction mixture was held at 150° C. until an acid number <3 mg KOH/g was reached and then diluted with butyl glycol acetate to a solids content of 80% by weight, at 120° C. The viscosity of the solution was 28 dPas (23° C.).

The low molecular mass hydrophobic polyester was used for preparing component (I).

### Preparation Example 5

The Preparation of Component (II)

Component (II) was prepared by mixing 70 parts by weight of a trimer of hexamethylene diisocyanate (Desmodur® XP 2410 from Bayer AG) and 30 parts by weight of butyl glycol acetate and homogenizing the resultant mixture in a stirrer vessel.

### Preparation Example 6

The Preparation of Component (III)

Component (III) was prepared by mixing the constituents described below in the stated order and homogenizing the resultant mixture in a stirrer vessel with a stirrer:
33.9 parts by weight of deionized water,
0.4 part by weight of a commercial rheological assistant (Dapral® T 210),
20 parts by weight of the dispersion of the water-soluble or water-dispersible methacrylate copolymer (A) from preparation example 3,
44 parts by weight of the dispersion of the water-soluble or water-dispersible polyurethane (A) from preparation example 2,
0.2 part by weight of dimethylethanolamine and
1.5 parts by weight of butyl glycol.

### Example 1

The Preparation of a Curable Oil-In-Water Dispersion (Clearcoat Material) Using a Multicomponent System

First of all a water-in-oil dispersion or component (I) was prepared by mixing the constituents described below in the stated order and homogenizing the resultant mixture in a stirrer vessel with a stirrer:
52 parts by weight of the organic solution of the water-soluble or water-dispersible methacrylate copolymer (A) from preparation example 1,
17.5 parts by weight of the low molecular mass hydrophobic polyester from preparation example 4,
8.3 parts by weight of butyl glycol acetate,
2 parts by weight of butyl glycol,
6 parts by weight of a commercial wetting agent (Deuterol® 201E),
1 part by weight of a commercial leveling agent based on a polyether-modified dimethylsiloxane copolymer (Byk® 331 from Byk Chemie),
0.7 part by weight of a commercial light stabilizer based on sterically hindered amines (HALS) (Tinuvin® 292 from Ciba Specialty Chemicals),
0.7 part by weight of a commercial UV absorber (Tinuvin® 1130 from Ciba Specialty Chemicals),
1.8 parts by weight of dimethylethanolamine and
10 parts by weight of deionized water.

The water-in-oil dispersion (I) was transportable and storage-stable.

For preparing the water-in-oil dispersion (I/II) 25 parts by weight of component (II) were added to 25 parts by weight of the water-in-oil dispersion (I). Mixing was carried out manually.

For preparing the oil-in-water dispersion or the clearcoat material the water-in-oil dispersion (I/II) was mixed manually with 50 parts by weight of component (III). The clearcoat material was adjusted manually to the spray viscosity using 25 parts by weight of deionized water. It had a processing life of several hours and could be applied without problems.

### Example 2

The Preparation of a Curable Oil-in-Water Dispersion (Clearcoat Material) Using a Multicomponent System

First of all a water-in-oil dispersion (I) was prepared by mixing the constituents described below in the stated order and homogenizing the resultant mixture in a stirrer vessel with a stirrer:
48 parts by weight of the organic solution of the water-soluble or water-dispersible methacrylate copolymer (A) from preparation example 1,
17.5 parts by weight of the low molecular mass hydrophobic polyester from preparation example 4,
8.3 parts by weight of butyl glycol acetate,
2 parts by weight of butyl glycol,
6 parts by weight of a commercial wetting agent (Deuterol® 201E),
1 part by weight of a commercial leveling agent based on a polyether-modified dimethylsiloxane copolymer (Byk® 331 from Byk Chemie),
0.7 part by weight of a commercial light stabilizer based on sterically hindered amines (HALS) (Tinuvin® 292 from Ciba Specialty Chemicals),
0.7 part by weight of a commercial UV absorber (Tinuvin® 1130 from Ciba Specialty Chemicals),
1.8 parts by weight of dimethylethanolamine and
14 parts by weight of component (III) from preparation example 6.

The water-in-oil dispersion (I) was transportable and storage-stable.

For preparing the mixture or the water-in-oil dispersion (I/II) 25 parts by weight of component (II) were added to 25 parts by weight of the water-in-oil dispersion (I). Mixing was carried out manually.

For preparing the oil-in-water dispersion or the clearcoat material the water-in-oil dispersion (I/II) was mixed manually with 50 parts by weight of component (III). The clearcoat material was adjusted manually to the spray viscosity using 25 parts by weight of deionized water. It had a processing life of several hours and could be applied without problems.

### Examples 3 and 4

The Production of Multicoat Paint Systems

The multicoat paint system of example 3 was produced using the clearcoat material of example 1. The multicoat paint system of example 4 was produced using the clearcoat material of example 2.

Commercially customary phosphated steel panels which had been coated with an electrocoat and a surfacer coat were coated with a conventional black aqueous basecoat material in accordance with European patent application EP 0 279 813 A1. The resultant aqueous basecoat films were flashed off at room temperature for five minutes and dried at 60° C. for ten minutes. The dried aqueous basecoat films were coated with the clearcoat materials in two spray passes, with a flash-off time of three to four minutes in between. The resultant clearcoat films were flashed off at room temperature for ten minutes and dried in a forced air oven at 60° C. for 45 minutes. The resultant multicoat paint systems had basecoats with a dry film thickness of 12 to 15 μm and clearcoats with a dry film thickness of 50 μm.

The clearcoats were clear and free from clouding and surface defects such as microbubbles and craters. They exhibited very good wetting and very good leveling. The overall visual impression was outstanding. The gloss (20°) and haze in accordance with DIN 67530 were 87 and 11.4 units (example 3) and 88 and 10.9 units (example 4), respectively.

1. A multicomponent system comprising:
(I) at least one water-in-oil dispersion comprising water and at least one water-soluble and/or water-dispersible, oligomeric and/or polymeric binder (A) having at least two isocyanate-reactive functional groups in solution and/or dispersion in at least one organic solvent;
(II) at least one water-free liquid component comprising least one polyisocyanate (B); and
(III) water or at least one aqueous component comprising at least one binder (A) in dispersion and/or solution in water.

2. The multicomponent system as claimed in claim 1, wherein the water-in-oil dispersion (I) has a water content of less than 40% by weight.

3. A process for preparing a multicomponent system, comprising:
mixing a portion of at least one component (III) with at least one component (I′) to give at least one water-in-oil dispersion (I),
wherein the component (I′) comprises at least one water-free liquid component which comprises at least one water-soluble and/or water-dispersible, oligomeric and/or polymeric binder (A) having at least two isocyanate-reactive functional groups in solution and/or dispersion in at least one organic solvent;
wherein the component (II) comprises at least one water-free liquid component comprising at least one polyisocyanate (B); and
wherein the component (III) comprises water or at least one aqueous component comprising at least one binder (A) in dispersion and/or solution in water.

4. The process as claimed in claim 3, wherein a portion of the at least one component (III) is mixed manually with the at least one component (I′).

5. A process for preparing an oil-in-water dispersion curable thermally or both thermally and with actinic radiation, which comprises using a multicomponent system comprising:
(I) at least one water-free liquid component comprising at least one water-soluble and/or water-dispersible, oligomeric and/or polymeric binder (A) having at least two isocyanate-reactive functional groups in solution and/or dispersion in at least one organic solvent;
(II) at least one water-free liquid component comprising at least one polyisocyanate (B); and
(III) water or at least one aqueous component comprising at least one polymeric binder (A) in dispersion and/or solution in water;
where the at least one component (I′), the at least one component (II), and the at least one component (III) are mixed with one another and where
(1) a portion of the at least one component (III) is mixed with the at least one component (I′) to give at least one water-in-oil dispersion (I),
(2) the at least one water-in-oil dispersion (I) is mixed with at least one component (II), and
(3) the resultant at least one mixture (I/II) is mixed with water or the at least one component (III) to give at least one oil-in-water dispersion.

6. The process as claimed in claim 5, wherein the at least one water-in-oil dispersion (I) has a water content of less than 40% by weight.

7. The process as claimed in claim 5, wherein the at least one mixture (I/II) is a water-in-oil dispersion.

8. The process as claimed in claim 5, wherein the process step (2) is carried out manually.

9. The process as claimed claim 5, wherein the process step (3) is carried out manually.

10. The use of an oil-in-water dispersion curable thermally or both thermally and with actinic radiation and prepared by the process as of claim 5 as a coating material, adhesive or sealant for producing a coating, adhesive layer or seal.

11. The use of a multicomponent system as claimed in claim 1 for preparing an oil-in-water dispersion curable thermally or both thermally and with actinic radiation.

12. The use as claimed in claim 11, wherein an oil-in-water dispersion curable thermally or both thermally and with actinic radiation is used as a coating material, adhesive or sealant for producing a coating, adhesive layer or seal.

13. The use as claimed in claim 10, wherein the coating material is a clearcoat material used for producing a clearcoat.

14. The use as claimed in claim 10, wherein the coating material, adhesive or sealant is used for the coating, adhesive bonding or sealing of bodies of means of transport.

15. The use as claimed in claim 14, wherein the means of transport is selected from the group consisting of means of transport operated by engine power and/or muscle power.

16. The use as claimed in claim 15, wherein the means of transport is selected from the group consisting automobiles, trucks, buses, bicycles, rail vehicles, watercraft, aircraft, parts thereof, and constructions and parts thereof.

17. The use as claimed in claim 10, wherein the coating material, adhesive or sealant is used for the coating, adhesive bonding or sealing an article selected from the group consisting of doors, windows, furniture, small industrial parts, mechanical components, optical components, electronic components, coils, containers, packaging, hollow glassware, and articles of everyday use.
